(19) United States
(12) Patent Application Publication
(10) Pub. No.: US 2011/0185122 A1
(43) Pub. Date: Jul. 28, 2011

(54) STORAGE SYSTEM AND METHOD OF PROCESSING DATA USING THE SAME

(75) Inventor: Jin Won Choi, Suwon-si (KR)

(73) Assignee: Samsung Electronics Co., Ltd., Suwon-si (KR)

(21) Appl. No.: 13/015,100

(22) Filed: Jan. 27, 2011

(30) Foreign Application Priority Data
Jan. 28, 2010 (KR) 2010-0008056

(51) Int. Cl. G06F 12/00

(52) U.S. Cl. 711/114; 711/E12.001

(57) ABSTRACT

A storage system includes a plurality of data processing devices connected in series. One of the data processing devices either accesses a first data storage device or transmits an access command output from a host to an next data processing device in the series according to the access command. The data processing device determines whether to access a second data storage device according to the received access command.

### CROSS-REFERENCE TO RELATED APPLICATIONS

This application claims the benefit of priority under 35 U.S.C. §119(a) from Korean Patent Application No. 10-2010-0008056, filed on Jan. 28, 2010, in the Korean Intellectual Property Office, the disclosure of which is incorporated herein in its entirety by reference.

### BACKGROUND

1. Field of the Invention

The present general inventive concept relates data processing technique, and more particularly, to a storage system capable of connecting a host and device by using a Redundant array of independent disks (RAID) method regardless of whether the host supports an RAID function, and a data processing method performed in the storage system.

2. Description of the Related Art

Generally, a storage device stores digital data in a storage medium. Examples of the storage device include an optical disk drive that uses an optical disk as a storage medium, a hard disk drive that uses a hard disk also called a platter as a storage medium, a floppy disk drive that uses a floppy disk as a storage medium, a zip drive that uses a portable disk as a storage medium, etc.

Various techniques have been developed to increase the speed of a data interface between a computer and a storage device. In the early 2000s, information apparatus manufacturers organized a Serial Advanced Technology Attachment Working Group to propose and spread new interfaces, and have started spreading a computer main board chip-set including a serial ATA(SATA) interface built therein and a storage device.

The SATA interface has the following various advantages. First, a data transmission rate has improved compared to a conventional parallel ATA (PATA) interface, and a rate of data loss caused due to the interference of an electromagnetic field generated around a cable has been reduced. In addition, the SATA interface is compatible with a conventional parallel ATA (PATA) interface. Accordingly, storage devices that interface with a SATA method and storage devices that interface with a PATA method may be used together. In the SATA interface, since data is transmitted in a serial manner, a cable width is reduced, and ventilation within a computer is improved. However, in the case of the SATA interface, a computer should support an redundant array of independent disks (RAID) technique in order to form a computer system together with a storage device by using the SATA interface.

### SUMMARY

The present general inventive concept provides a storage system capable of connecting a host to a device by using a redundant array of independent disks (RAID) method regardless of whether the host supports an RAID function, and a data processing method performed in the storage system.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a storage system including N (where N denotes a natural number) data processing devices each including a data storage device and serially connected to one another. An i-th (where i denotes a natural number of 1≦i<N) data processing device from among the N data processing devices may access a first data storage device of the i-th data processing device or may transmit an access command output from a host to an (i+1)th data processing device according to the access command. The (i+1)th data processing device may determine whether to access a second data storage device of the (i+1)th data processing device according to the received access command.

When the i-th data processing device has accessed the first data storage device, the i-th data processing device may transmit a result of the accessing to the host. When the (i+1)th data processing device has accessed the second data storage device, the (i+1)th data processing device may transmit a result of the accessing to the host via the i-th data processing device.

When the access command is a read command and the read command includes a read address, the i-th data processing device may compare the read address with a first address and may read data corresponding to the read address from the first data storage device and may transmit the read-out data to the host, or may transmit the read command to the (i+1)th data processing device, according to a result of the comparison, and the (i+1)th data processing device may compare the read address included in the read command with a second address and may determine according to a result of the comparison whether to access the second data storage device.

When the read address is identical to the second address, the (i+1)th data processing device may read data corresponding to the read address from the second data storage device and may transmit the read-out data to the host via the i-th data processing device. When the read address is not identical to the second address, the (i+1)th data processing device may transmit the read command to an (i+2)th data processing device.

When the access command is a write command and the write command includes a write address and write data, the i-th data processing device may compare the write address with a first address and writes the write data to the first data storage device or may transmit the write command to the (i+1)th data processing device, according to a result of the comparison, and the (i+1)th data processing device may compare the write address included in the write command with a second address and may determine according to a result of the comparison whether to access the second data storage device.

When the write address is identical to the second address, the (i+1)th data processing device may write the write data to the second data storage device. When the write address is not identical to the second address, the (i+1)th data processing device may transmit the write command to an (i+2)th data storage device.

According to embodiment, the i-th data processing device and the (i+1)th data processing device are hard disk drives. According to another embodiment, the i-th data storage device and the (i+1)th data storage device are magnetic recording media. According to still another embodiment, one of the i-th data storage device and the second data storage device is one of a magnetic recording medium and a non-volatile memory device.

According to another aspect of the present general inventive concept, there is provided a method of processing data by using a storage system, the storage system including N data processing devices each including a data storage device and serially connected to one another, the method including an operation in which an i-th data processing device from among the N data processing devices may access a first data storage device of the i-th data processing device or may transmit an access command output from a host to an (i+1)th data processing device according to the access command; and an operation in which the (i+1)th data processing device may determine whether to access a second data storage device of the (i+1)th data processing device according to the received access command.

When the i-th data processing device has accessed the first data storage device, the i-th data processing device may transmit a result of the accessing to the host. When the (i+1)th data processing device has accessed the second data storage device, the (i+1)th data processing device may transmit a result of the accessing to the host via the i-th data processing device.

When the access command is a read command and the read command includes a read address, the i-th data processing device may compare the read address with a first address and may read data corresponding to the read address from the first data storage device and may transmit the read-out data to the host, or may transmit the read command to the (i+1)th data processing device, according to a result of the comparison, and the (i+1)th data processing device may compare the read address included in the read command with a second address and may determine according to a result of the comparison whether to access the second data storage device.

When the read address is identical to the second address, the (i+1)th data processing device may read data corresponding to the read address from the second data storage device and may transmit the read-out data to the host via the i-th data processing device.

The method may further include an operation in which, when the read address is not identical to the second address, the (i+1)th data processing device may transmit the read command to an (i+2)th data processing device.

When the access command is a write command and the write command includes a write address and write data, the i-th data processing device may compare the write address with a first address and may write the write data to the first data storage device or may transmit the write command to the (i+1)th data processing device, according to a result of the comparison, and the (i+1)th data processing device may compare the write address included in the write command with a second address and may determine according to a result of the comparison whether to access the second data storage device. When the write address is identical to the second address, the (i+1)th data processing device may write the write data to the second data storage device.

Features and/or utilities of the present general inventive concept may also be realized by a data storage system including a host device and a plurality of data storage devices connected in series, only a first one of the plurality of data storage devices connected to the host device, and a last one of the plurality of data storage devices in the series connected only to an adjacent data storage device. The first data storage device may determine whether a communication from the host corresponds to an address in the first data storage device, and may transmit the communication to a next data storage device in the series when the communication does not correspond to an address in the first data storage device.

Each of the plurality of data storage devices may include a first memory device to store data, and the address may correspond to a location on one of the plurality of first memory devices.

The first data storage device may include a non-volatile memory to store addresses corresponding to a data storage disk of the first data storage device and a range of addresses corresponding each of the other storage devices.

The addresses corresponding to each of the other storage devices may not be distinguished in the first memory according to which addresses correspond to which of the plurality of storage devices.

The host may include a controller having memory, and the memory of the host controller may have stored addresses corresponding to the plurality of data storage devices.

The addresses corresponding to the plurality of data storage devices may not be distinguished in the controller memory according to which addresses correspond to which of the plurality of storage devices.

Each of the plurality of data storage devices other than the last data storage device may include a first communication port to communicate with an upstream device from among the host device and the plurality of data storage devices, a second communication port to communicate with a downstream device from among the plurality of data storage devices, a first memory to store addresses corresponding to the respective data storage device and to store a range of addresses corresponding to each downstream device, a second memory to store data located at the addresses corresponding to the respective data storage device, and a read/write circuit to read data from and write data to the second memory.

Features and/or utilities of the present general inventive concept may also be realized by a data storage device in a series of data storage devices having a host device connected at an upstream end including a first communication port to communicate with an upstream device, a second communication port to communicate with a downstream device, a first memory to having addresses to store data, a second memory to store address values corresponding to the first memory, and a controller to determine whether a first communication received from the first communication port may correspond to the address values stored in the second memory, and to transmit the first communication to the second communication port when the first communication does not correspond to the address values stored in the second memory.

The controller may transmit each communication received from the second communication port to the first communication port.

Features and/or utilities of the present general inventive concept may also be realized by a method of storing data in a plurality of data storage devices connected in series, the method including transmitting a communication corresponding to a first address to a first data storage device in the series of data storage devices, determining whether the first address may correspond to the first data storage device, and transmitting the communication to a next data storage device in the series when the communication does not correspond to an address of the first data storage device.

Determining whether the first address may correspond to the first data storage device may include comparing address information in the communication to address values stored in a memory of the first data storage device.

The method may further include after transmitting the communication to the next data storage device, receiving a response from the next data storage device, and transmitting the response to a previous data storage device of the series.

A data storage device at one end of the series may be a host device to initiate each communication with the plurality of data storage devices.

The method may further include connecting a second data storage device to an end of the series of data storage devices, and transmitting address information corresponding to the second data storage device to a previous data storage device in the series.

Each data storage device upstream in the series from the second data storage device may save the address information of the second data storage device to memory in each respective data storage device.

Features and/or utilities of the present general inventive concept may also be realized by a method of storing data in a plurality of data storage devices connected in series, the method including receiving at a first data storage device of the plurality of data storage devices a communication having address information, determining whether the address information may correspond to a memory address of the first data storage device, and transmitting the communication to a next data storage device in the series when the address information does not correspond to the first data storage device.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a schematic block diagram of a storage system according to an embodiment of the present general inventive concept;

FIG. 2 is a flowchart of a method in which a host reads data from a plurality of devices, in the storage system illustrated in FIG. 1;

FIG. 3 is a flowchart of a method in which the host writes data to the plurality of devices, in the storage system illustrated in FIG. 1;

FIG. 4 is a schematic block diagram of a storage system according to another embodiment of the present general inventive concept;

FIG. 5 is a flowchart of a method in which a host reads data from a plurality of devices, in the storage system illustrated in FIG. 4; and

FIG. 6 is a flowchart of a method in which the host writes data to the plurality of devices, in the storage system illustrated in FIG. 4;

FIGS. 7A and 7B illustrate configurations of memory of a host device and memory devices according to embodiments of the present general inventive concept;

FIG. 8 illustrates a method of adding a device to a series of memory devices;

FIGS. 9A and 9B illustrate example physical structures of a host device and memory devices according to embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, a storage device that can store data and performs interface using a serial ATA (SATA) method is referred to as a ‘device’, and a processor or device including a processor that is connected to the device and controls the device is referred to as a ‘host’. The “device” may also be referred to as a data processing device or data storage device. In the present specification and claims, the terms “upstream” and “downstream” refer to a flow of data in a series of devices connected serially. “Upstream” refers to devices located closer to the host, and “downstream” refers to devices located farther from the host. Similarly, a “next” device refers the immediately adjacent device to the subject device in the series downstream from the subject device, and a “previous” device refers to the immediately adjacent device in the series upstream from the subject device, unless otherwise specifically indicated.

In the present specification and claims, a “first device in a series” refers to the upstream-most device, while a “first device” refers only to one device from among more than one device, and not necessarily to the “first device in the series.” In other words, the term “in a series” or “in the series” refers to an order of devices in the series. Similarly, the “last device” refers to the last device in the series of devices, where the “first device in the series” is the upstream-most device and the last device is the downstream-most device.

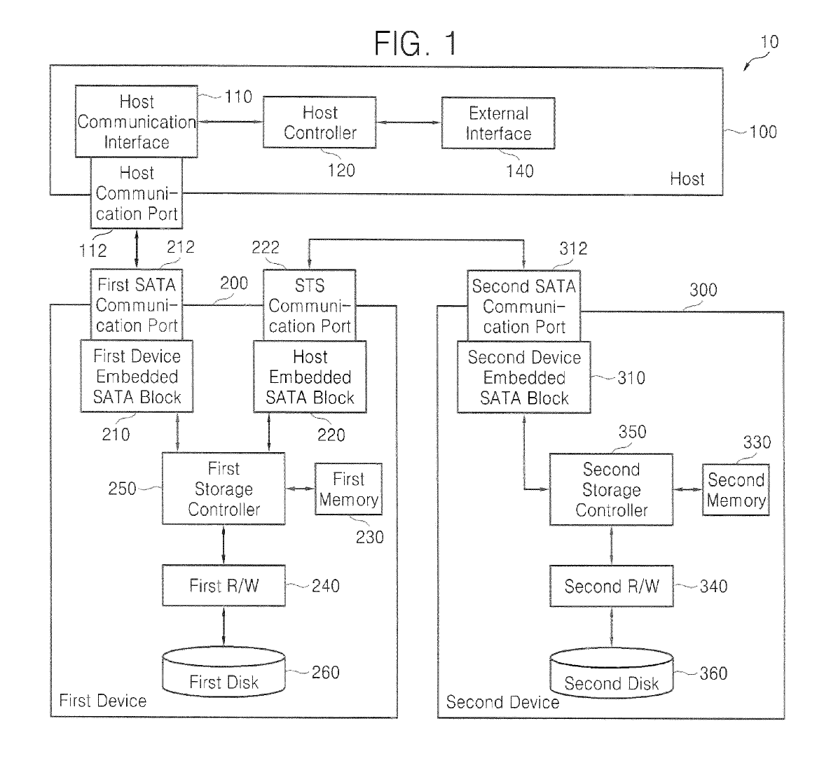

FIG. 1 is a schematic block diagram of a storage system 10 according to an embodiment of the present general inventive concept. The data processing system 10 or data storage system 10 such as a computer system includes a host 100, a first device 200, and a second device 300. Each of the first device 200 and the second device 300 may be a data processing device including a magnetic recording medium, for example, a hard disk drive (HDD). According to another embodiment, each of the first device 200 and the second device 300 may be a data processing device such as a solid state drive (SSD) or a hybrid HDD. The host 100, the first device 200, and the second device 300 may transmit data to or receive data from one another according to an SATA method.

The host 100 may transmit an access command, for example, a read command or a write command, to the first device 200 or the second device 300 and thus may read data from the first device 200 or the second device 300 or write data to the first device 200 or the second device 300. When the access command is a write command, the write command may denote a command including a write address and write data.

The host 100 includes a host communication interface 110 and a host controller 120. The host communication interface 110 may include a host communication port 112 and may be physically connected to the first device 200 or the second device 300 via the host communication port 112. In other words, the host 100 may communicate with the first device 200 or the second device 300 via the host communication port 112. The host 100 may include an external interface 140 to receive input from another device or from a user. For example, the host 100 may be a server to receive input from a user terminal, or the host 100 may be a user terminal and the external interface 140 may be a keyboard, mouse, touch-screen, or other user input.

The host controller 120 controls the entire operation of the host 100. The host controller 120 may generate a read command for reading data from at least one of the first device 200 and the second device 300 or a write command for writing data to at least one of the first device 200 and the second device 300. The read command or the write command is transmitted to the first device 200 or the second device 300 via the host communication port 110.

The host communication interface 110 may transmit the read command or the write command received from the host controller 120 to the first device 200 or the second device 300. The host communication interface 110 also receives read data from the first device 200 or the second device 300 via the host communication port 112 and transmits the read data to the host controller 120.

The first device 200 and the second device 300 may be connected to each another according to an RAID method and thus recognized as a single device by the host 100. The first device 200 connected to the second device 300 performs an operation corresponding to at least one command received from the host 100, for example, a read command or a write command.

When data corresponding to the read command received from the host 100 is stored in a second disk 360 or a second memory 330 of the second device 300, the first device 200 controls the second device 300 so that the data stored in the second device 300 can be transmitted to the host 100 via the first device 200. Also, when data corresponding to the write command received from the host 100 needs to be written to the second device 300, the first device 200 controls the second device 300 so that the data can be written to a location of the data, for example, to a location designated by an address included in the write command.

The first device 200 may include a first device embedded SATA block 210, a host embedded SATA block 220, a first memory 230, a first read/write circuit 240 (hereinafter, referred to as a first R/W), a first storage controller 250, and a first disk 260. The first disk 260 may be a magnetic recording medium which is an example of a data storage device.

The first device embedded SATA block 210 performs communication between the first device 200 and the host 100. The first device embedded SATA block 210 may include a first SATA communication port 212 and may communicate with the host communication port 112 of the host 100 via the first SATA communication port 212. The first device embedded SATA block 210 receives a command transmitted by the host 100, for example, a read command or a write command, and transmits data stored in the first device 200 or data received from the second device 300 to the host 100.

The host embedded SATA block 220 performs communication between the first device 200 and the second device 300. The host embedded SATA block 220 may include a STS (SATA to SATA) communication port 222 and may communicate with a second SATA communication port 312 of the second device 300 via the STS communication port 222. The host embedded SATA block 220 transmits a read command or a write command received from the first device 200 to the second device 300 and receives data from the second device 300.

The first memory 230 stores all data, for example, a firmware code, for operating the first device 200. The first memory 230 may store information about all addresses allocated to store data in the first device 200 and information about all addresses allocated to store data in the second device 300.

The first R/W 240 reads or writes data from or to the first disk 260 of the first device 200. For example, the first R/W 240 may read data corresponding to the read command received from the host 100 from the first memory 230 or the first disk 260 under the control of the first storage controller 250 or transmit the read-out data to the first storage controller 250. The first R/W 240 writes data corresponding to the write command received from the host 100 to the first memory 230 or the first disk 260.

The first storage controller 250 controls the entire operation of the first device 200. The first storage controller 250 interprets or decodes the read command received from the host 100 via the first device embedded SATA block 210. The first storage controller 250 determines where data corresponding to the interpreted or decoded read command is stored. The first storage controller 250 determines whether an address included in the read command is an address assigned to the first device 200 or the second device 300.

When the address included in the read command is an address assigned to the first device 200, the first storage controller 250 controls the first device 200 to read data corresponding to the address from the first memory 230 or the first disk 260 and to transmit the read-out data to the host 100. On the other hand, when the address included in the read command is not the address assigned to the first device 200 but an address assigned to the second device 300, the first storage controller 250 controls the first device 200 to request the second device 300 for data corresponding to the address.

The first storage controller 250 may transmit the read command received from the host 100 to the second device 300 via the host embedded SATA block 220. In other words, the first storage controller 250 may request the second device 300 for the data corresponding to the read command. Since the read command includes an address of the data requested by the host 100, the first storage controller 250 may transmit the read command to the second device 300 so that the second device 300 can read the data by referring to or decoding the address.

When the second device 300 reads the data corresponding to the read command from the second memory 330 or the second disk 360 and transmits the read-out data to the first device 200 via the host embedded SATA block 220 connected to the second device embedded SATA block 310, the first storage controller 250 transmits the data received from the second device 300 to the host 100 via the first device embedded SATA block 210.

Also, the first storage controller 250 receives and decodes the write command received from the host 100 via the first device embedded SATA block 210. When generating the write command, the host controller 120 may determine an address for indicating the location to which data is to be written according to the write command. The host controller 120 generates the write command including the address. The first storage controller 250 receives and decodes the address included in the write command.

The first storage controller 250 determines whether the address included in the write command is an address assigned to the first device 200 or the second device 300. When the address included in the write command is an address assigned to the first device 200, the first storage controller 250 writes data to the first memory 230 or the first disk 260 that is indicated by the address. On the other hand, when the address included in the write command is not an address assigned to the first device 200 but an address assigned to the second device 300, the first storage controller 250 requests the second device 300 to write the data output from the host 100 to the second device 300.

The first storage controller 250 transmits the write command received from the host 100 to the second device 300 via the host embedded SATA block 220 and the second device embedded SATA block 310. In other words, the first storage controller 250 may request the second device 300 to perform a data write operation. Since the write command includes an address where the data is to be written, the first storage controller 250 may transmit the write command to the second device 300 so that the second device 300 can write the data to the second memory 330 or the second disk 360 by referring to or decoding the address.

The second device 300 includes the second device embedded SATA block 310, the second memory 330, a second read/write circuit 340 (hereinafter, referred to as a second R/W 340), a second storage controller 350, and the second disk 360. The second disk 360 may be a magnetic recording medium which is an example of a data storage device.

The second device embedded SATA block 310 performs communication between the first device 200 and the second device 300. The second device embedded SATA block 310 includes a second SATA communication port 312. The second SATA communication port 312 is connected to the STS communication port 222 of the first device 200. Accordingly, the second device 300 can communicate with the first device 200. The second device embedded SATA block 310 receives a read command, a write command, or data from the first device 200 and transmits data received from the second memory 330 or the second disk 360 to the first device 200.

The second memory 330 stores all data, for example, a firmware code, for controlling an operation of the second device 300. The second memory 330 may store information about all addresses assigned to store data in the second memory 330 or the second disk 360 of the second device 300.

The second R/W 340 may read data from the second disk 360 of the second device 300 or newly write data to the second disk 360 of the second device 300. The second R/W 340 may read data from the second disk 360 according to the read command received from the first device 200 or store data corresponding to the write command in the second disk 360, under the control of the second storage controller 350.

The second storage controller 350 controls the entire operation of the second device 300. When a read command is received from the first device 200 via the second device embedded SATA block 310, the second storage controller 350 decodes an address included in the read command. The second storage controller 350 controls the second R/W 340 to read data located at the address from the second disk 360. When the data is read, the second storage controller 350 transmits the data to the first device 200 via the second device embedded SATA block 310.

When the address is not an address assigned to the second device 300 or data corresponding to the address is not stored in the second device 300, the second storage controller 350 may inform the first device 200 that the data does not exist.

The second storage controller 350 receives the write command from the first device 200 via the second device embedded SATA block 310 and decodes the write command. The second storage controller 350 decodes an address included in the write command and controls the second R/W 340 to write to the second disk 360 data that corresponds to the address and is received from the first device 200.

The first device 200 or the second device 300 may be a hard disk drive (HDD) such as a magnetic recording medium, or a non-volatile memory such as a solid state drive (SSD) including a flash memory.

Although the host 100 does not support an RAID function, since the first device 200 is able to control the second device 300, the first device 200 may read desired data requested by the host 100 from the second device 300 or write desired data to the second device 300. In other words, the storage system 10 of FIG. 1 may support the RAID function by the first device 200.

For example, while in a typical RAID configuration a host may store addresses corresponding to multiple connected devices separately, so as to be able to communicate with the devices separately, a host 100 of the present general inventive concept may store all the addresses of each connected device (e.g. 200, 300) together as a block. The host 100 may send a command to the first device 200 to write to or read from any address in the block, and the host may not be able to distinguish between an address located on the first device 200 or the second device 300. In other words, since the addresses corresponding to the respective devices 200 and 300 or not distinguished in the memory of the host 100, the host 100 cannot select from among the connected devices 200 and 300 for communication. Instead, the host 100 communicates with only the first device 200, and the first device 200 determines whether the communication corresponds to the first device 200 or the second device 300, as discussed previously.

Alternatively, the host 100 may store address values that distinguish between the respective devices 200 and 300, and the host may add a flag or marker in a communication to indicate to the first device 200 whether to process the communication or to pass the communication to the second device 300.

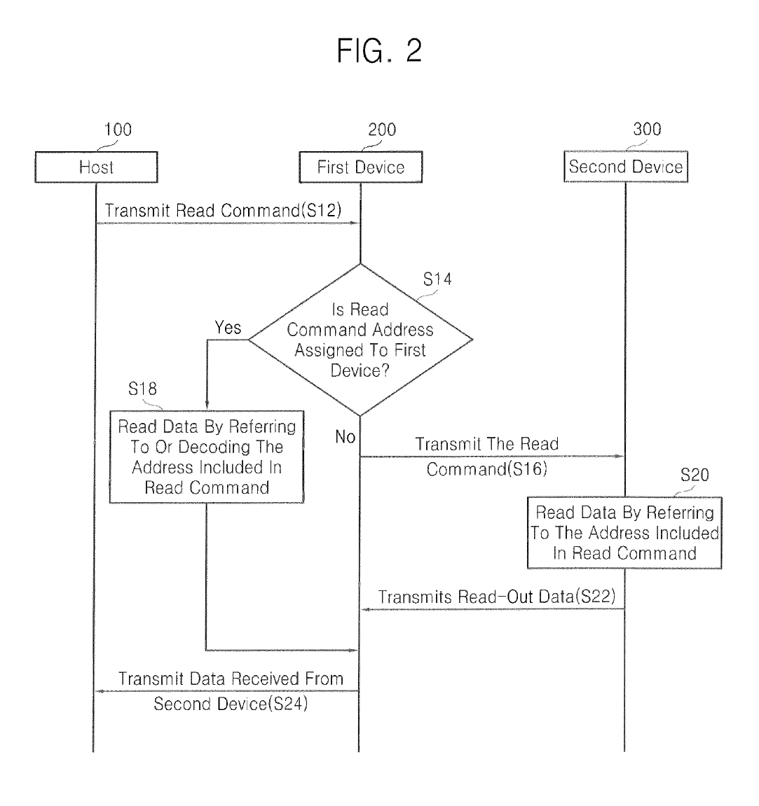

FIG. 2 is a flowchart of a method in which the host 100 reads data from a plurality of devices, namely, the first and second devices 200 and 300, in the storage system 10 illustrated in FIG. 1. Referring to FIGS. 1 and 2, in operation S12, the host 100 transmits a read command to the first device 200 via the host communication interface 110 under the control of the host controller 120. In response to the read command, the first device 200 determines in operation S14 whether an address included in the read command is an address assigned to the first device 200.

The first device 200 compares the address included in the read command with an address pre-stored in the first memory 230. When the address included in the read command is an address assigned to the first device 200, the first device 200 determines that data corresponding to the read command exists in the first device 200, for example, the first disk 260.

On the other hand, when the address included in the read command is not an address assigned to the first device 200, the first device 200 determines that the data corresponding to the read command does not exist in the first device 200. FIG. 2 assumes that when the data is not stored in the first device 200, the data is stored in the second device 300.

When it is determined in operation S14 that the address included in the read command is an address assigned to the first device 200, the first device 200 reads data from the first disk 260 in operation S18 by referring to or decoding the address included in the read command. On the other hand, when it is determined in operation S14 that the address included in the read command is not an address assigned to the first device 200, the first device 200 transmits the read command to the second device 300 under the control of the first storage controller 250 in operation S16.

In response to the read command received from the first device 200, the second device 300 reads data in operation S20 corresponding to the address included in the read command from the second disk 360 by referring to the address, and transmits the read-out data to the first device 200 in operation S22. In operation S24, the first device 200 transmits the data received from the second device 300 to the host 100 according to the read command.

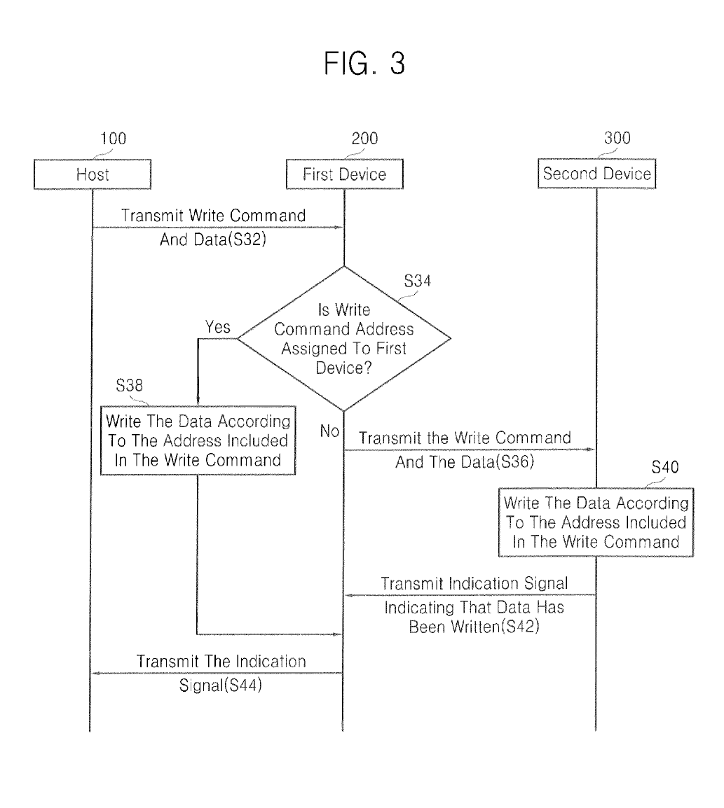

FIG. 3 is a flowchart of a method in which the host 100 writes data to a plurality of devices, namely, the first and second devices 200 and 300, in the storage system 10 illustrated in FIG. 1. Referring to FIGS. 1 and 3, in operation S32, the host 100 transmits a write command to the first device 200 via the host communication interface 110 under the control of the host controller 120.

In response to the write command received from the host 100, the first device 200 determines in operation S34whether an address included in the write command is an address allocated to the first device 200. The first device 200 compares the address included in the write command with each of an address for the first device 200 and an address for the second device 300, which are stored in the first memory 230.

When it is determined in operation S34 that the address included in the write command is an address allocated to the first device 200, the first device 200 writes data received from the host 100 to the first disk 260 in operation S38 according to the address included in the write command.

On the other hand, when it is determined in operation S34 that the address included in the write command is not an address assigned to the first device 200, the first device 200 transmits the write command and data to the second device 300 in operation S36. FIG. 3 assumes that when the address included in the write command is not an address assigned to the first device 200, the address is an address assigned to the second device 300. However, according to an alternative embodiment, the first memory 230 of the first device 200 may store the address ranges of each of the first and second devices 200 and 200 and may compare the address included in the write command to the stored range. If the address of the write command does not fall within the stored range, the first device 200 may send an error communication to the host 100.

When the first device 200 sends the write command and corresponding data, the second device 300, in operation S40, writes the data received from the first device 200 to the second disk 360 according to the address included in the write command, and transmits to the first device 200 in operation S42 an indication signal indicating that the data has been written. The first device 200 may transmit the indication signal to the host 100 in operation S44.

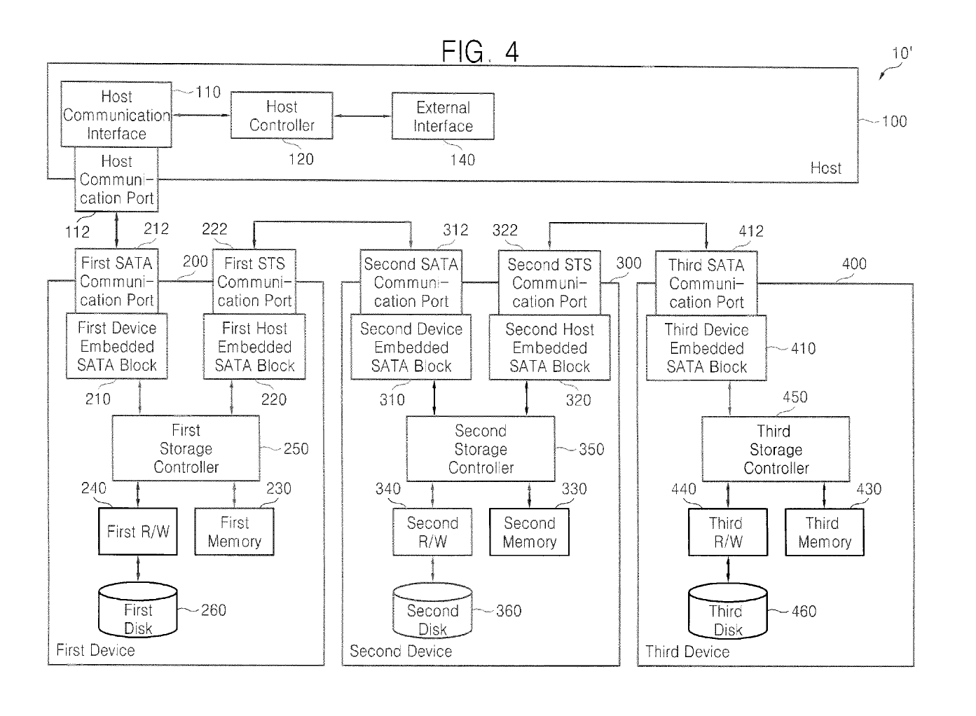

FIG. 4 is a schematic block diagram of a storage system 10′ according to another embodiment of the present general inventive concept. The storage system 10′ may include a host 100, a first device 200, a second device 300, and a third device 400. The first device 200, the second device 300, and the third device 400 may be hard disk drives each including a magnetic recording medium such as a hard disk or other memory.

The host 100 may transmit an access command, for example, a read command or a write command, to the first device 200, the second device 300, or the third device 400. Accordingly, the host 100 may transmit or receive data to or from the first device 200, the second device 300, or the third device 400. For example, the host 100 may read data from the first device 200, the second device 300, or the third device 400 or transmit data to the first device 200, the second device 300, or the third device 400.

The host 100 includes a host communication interface 110 and a host controller 120. The host communication interface 110 may include a host communication port 112 and may be physically connected to the first device 200 or the second device 300 via the host communication port 112.

The host communication interface 110 communicates with the first device 200 by using the host communication port 112. The host communication interface 110 may transmit a read command, a write command, and data corresponding to the write command from the host controller 120 to the first device 200, the second device 300, or the third device 400. The host communication interface 110 may receive data from the first device 200, the second device 300, or the third device 400 via the host communication port 112 and may transmit the received data to the host controller 110.

The host controller 120 controls the entire operation of the host 100. The host controller 120 may generate a read command, a write command, and data corresponding to the write command which are to be transmitted to the first device 200, the second device 300, or the third device 400. The host controller 120 may transmit the read command, the write command, and the data corresponding to the write command to the first device 200, the second device 300, or the third device 400 via the host communication interface 110.

The first device 200, the second device 300, and the third device 400 may be connected to one another using an RAID method and recognized as a single device by the host 100.

The first device 200 interprets or decodes the read command or the write command received from the host 100. When data corresponding to the read command is stored in the second device 300, the first device 200 may receive the data from the second device 300 and transmit the received data to the host 100. When the data corresponding to the read command is stored in the third device 400, the first device 200 may request the second device 300 to transmit the data to the first device 200. In response to the request, the second device 300 receives the data corresponding to the read command from the third device 400 and transmits the data to the first device 200.

When data corresponding to the write command is to be written to the second device 300, the first device 200 may control the second device 300 to write to the second disk 360 the data that corresponds to the write command and is output from the host 100. When the data is to be written to the third device 400, the first device 200 may control the second device 300 to write the data output from the host 100 to the third disk 460 of the third device 400.

The first device 200 includes a first device embedded SATA block 210, a first host embedded SATA block 220, a first memory 230, a first R/W 240, a first storage controller 250, and a first disk 260.

The first device embedded SATA block 210 performs communication between the first device 200 and the host 100. The first device embedded SATA block 210 may receive a read command or write data transmitted together with a write command from the host 100. The first device embedded SATA block 210 may transmit data output from the first disk 260 of the first device 200, the second disk 360 of the second device 300, or the third disk 460 of the third device 400 to the host 100.

The first host embedded SATA block 220 performs communication between the first device 200 and the second device 300. The first host embedded SATA block 220 may include a first STS (or a first SATA to SATA) communication port 222 and thus may be connected to a second SATA communication port 312 of the second device 300 via the first STS communication port 222 so as to communicate with the second device 300. The first host embedded SATA block 220 receives a command, for example, a read command or a write command, from the host 100 via the first storage controller 250 and transmits the command to the second device 300, and transmits data stored in the second disk 360 of the second device 300 to the host 100.

The first memory 230 stores all data used to operate the first device 200. The first memory 230 may store address information of the first device 200, address information of the second device 300, and/or address information of the third device 400.

The first R/W 240 reads data from the first disk 260 or writes specific data to the first disk 260. The first R/W 240 reads data corresponding to the read command received from the host 100 or writes data corresponding to the write command received from the host 100 to the first disk 260 of the first device 200, under the control of the first storage controller 250. The first R/W 240 writes the data to a location corresponding to an address specified by the write command.

The first storage controller 250 controls the entire operation of the first device 200. When the read command is received from the host 100 via the first device embedded SATA block 210, the first storage controller 250 decodes an address included in the read command to determine whether the address is an address assigned to the first device 200, an address assigned to the second device 300, or an address assigned to the third device 400. When the address included in the read command is an address assigned to the first device 200, the first storage controller 250 controls the first device 200 to read data from the first disk 260 according to the address and transmit the read-out data to the host 100. When the address included in the read command is not an address assigned to the first device 200, the first storage controller 250 requests the second device 300 to transmit data corresponding to the address to the first device 200. The first storage controller 250 may transmit the read command received from the host 100 to the second device 300 via the first host embedded SATA block 220. Accordingly, the first storage controller 250 may request the second device 300 for the data corresponding to the read command.

Since the read command includes an address indicating a location where the data has been stored, the second device 300 may read the data from the second disk 360 according to the address received from the first storage controller 250 and may transmit the read-out data to the first device 200. The first storage controller 250 transmits the data received from the second device 300 to the host 100 via the first host embedded SATA block 210.

The first storage controller 250 also receives the write command and data from the host 100 via the first device embedded SATA block 210 and decodes the write command. The first storage controller 250 decodes an address included in the write command and determines whether the decoded address is an address assigned to the first device 200, an address assigned to the second device 300, or an address assigned to the third device 400.

When the address included in the write command is an address assigned to the first device 200, the first storage controller 250 controls the first R/W 240 to write the data received from the host 100 to the first disk 260. On the other hand, when the address included in the write command is not the address assigned to the first device 200 but the address assigned to the second device 300 or the third device 400, the first storage controller 250 requests the second device 300 to write the data.

For example, the first storage controller 250 transmits the write command and the data output from the host 100 to the second device 300 via the first host embedded SATA block 220. Accordingly, the first storage controller 250 may request the second device 300 to write the data. Since the write command includes an address indicating a location to which the data is to be written, the first storage controller 250 transmits the write command to the second device 300.

The second device 300 includes the second device embedded SATA block 310, the second host embedded SATA block 320, the second memory 330, the second R/W 340, the second storage controller 350, and the second disk 360.

The second device embedded SATA block 310 performs communication between the first device 200 and the second device 300. The second host embedded SATA block 320 performs communication between the second device 300 and the third device 400. The second device embedded SATA block 320 includes a second STS communication port 322. The second STS communication port 322 is connected to a third SATA communication port 412 of the third device 400. Accordingly, the two devices 300 and 400 may communicate with each other via the two communication ports 322 and 412. The second device embedded SATA block 320 transmits at least one of a read command, a write command, or data corresponding to the write command received from the first device 200 to a third device embedded SATA block 410 of the third device 400, and receives data from a third memory 430 or a third disk 460 of the third device 400.

The second memory 330 stores all of data, for example, a firmware code, used to operate the second device 300. The second memory 330 may store at least one of an address assigned to store data received from the host 100 in the second device 300 and an address assigned to store the data in the third device 400.

The second R/W 340 may read data from the second disk 360 of the second device 300 or write the data output from the host 100 to the second disk 360 of the second device 300. The second R/W 340 reads data from the second disk 360 according to the read command received from the first device 200, that is, the read command transmitted by the host 100, under the control of the second storage controller 350. The second R/W 340 stores the write command and the data received from the first device 200, that is, the write command and the data transmitted by the host 100, in the second disk 360.

The second storage controller 350 controls the entire operation of the second device 300. The second storage controller 350 receives a read command from the first device 200 via the second device embedded SATA block 310, and decodes an address included in the read command. The second storage controller 350 determines where data corresponding to the received address is stored, by referring to the received address and an address stored in the second memory 330.

For example, the second storage controller 350 decodes the address included in the read command and determines whether the decoded address is an address assigned to the second device 300 or an address assigned to the third device 400.

When the address included in the read command is an address assigned to the second device 300, the second storage controller 350 reads data from the second disk 360 according to the received address and transmits the read-out data to the first device 200 via the second device embedded SATA block 310 and the first host embedded SATA block 220.

On the other hand, when the address included in the read command is an address assigned to the third device 400, the second storage controller 350 transmits the read command received from the first device 200 to the third device 400 via the second host embedded SATA block 320 and the third device embedded SATA block 410.

The third device 400 decodes an address included in the read command and thus reads data from the third disk 460 and transmits the read-out data to the second device 300 via the third device embedded SATA block 410 and the second host embedded SATA block 320. The data read from the third disk 460 according to the read command is transmitted to the host 100 via the second device 300 and the first device 200.

The second storage controller 350 receives a write command and data from the first device 200 and decodes a write address included in the write command. The second storage controller 350 determines whether the decoded write address is an address assigned to the second device 300 or an address assigned to the third device 400.

If the write address is an address assigned to the second device 300, the second storage controller 350 writes the write data to the second disk 360 according to the write address. On the other hand, when the write address is an address assigned to the third device 400, the second storage controller 350 transmits the write address and the write data to the third device 400.

The third device 400 includes the third device embedded SATA block 410, the third memory 430, a third R/W 440, a third storage controller 450, and the third disk 460. The third disk 460 may be a magnetic recording medium which is an example of a data storage device.

The third device embedded SATA block 410 performs communication between the second device 300 and the third device 400. The third device embedded SATA block 410 includes a third SATA communication port 412. The third SATA communication port 412 is connected to the second STS communication port 322 of the second device 300. The third device embedded SATA block 410 may receive the read command, the write command, or the write data from the second device 300 and transmit read data received from the third disk 460 of the third device 400 to the second device 300.

The third memory 430 stores all of data, for example, a firmware code, used to operate the third device 400. The third memory 430 may store an address assigned to store write data to the third disk 460 or an address assigned to read data from the third disk 460.

The third R/W 440 may read or write data from or to the third disk 460. The third R/W 440 reads data from the third disk 460 according to the read command received from the second device 300, under the control of the third storage controller 450. The third R/W 440 may write the write data received from the second device 300, that is, the write data transmitted by the host 100, to the third disk 460 according to the write command received from the second device 300.

The third storage controller 450 controls the entire operation of the third device 400. The third storage controller 450 decodes a read address included in the read command received from the second device 300 via the third device embedded SATA block 410 and controls the third R/W 440 to read data from the third disk 460 and transmit the read-out data to the second device 300 via the third device embedded SATA block 410.

In some cases, when data corresponding to the read address does not exist in the third disk 460, the third storage controller 450 may inform the second device 300 that the data does not exist. The third storage controller 450 may receive the write command and the write data from the second device 300 via the third device embedded SATA block 410 and control the third R/W 440 to write the write data to the third disk 460.

Although the host communication interface 110 is connected to the first device 200 in FIG. 4, the host communication interface 110 may be connected to the second device 300 or to the third device 400.

The first, second, and third devices 100, 200, and 300 may be classified into devices including the host embedded SATA blocks 220 and 320 like the first and second devices 200 and 300, and a device including no host embedded SATA blocks like the third device 400. In other words, the last device (e.g., the second device 300 of FIG. 1 or the third device 400 of FIG. 4) from among a plurality of devices may be the device including no host embedded SATA blocks.

In the storage system 10′ of FIG. 4, although the host 100 does not support an RAID function, the host 100 may write or read data to or from the second device 300 by using the first device 200. The host 100 may also write or read data to or from the third device 400 by using the first and second devices 200 and 300.

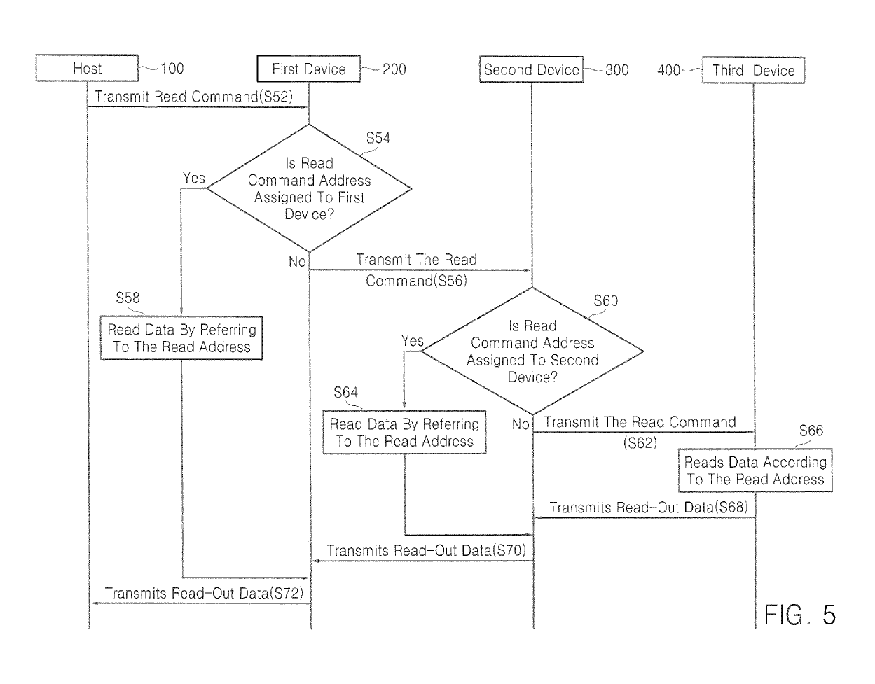

FIG. 5 is a flowchart of a method in which the host 100 reads data from a plurality of devices, namely, the first, second, and third devices 200, 300, and 400, in the storage system 10′ illustrated in FIG. 4. Referring to FIGS. 4 and 5, in operation S52, the host 100 transmits a read command to the first device 200 via the host communication interface 110.

In response to the read command, in operation S54, the first device 200 decodes a read address included in the read command and determines according to a result of the decoding whether the read address included in the read command is an address assigned to the first device 200. In other words, the first device 200 decodes the read address and determines according to a result of the decoding whether data desired to be read by the host 100 is stored in the first disk 260 of the first device 200.

When it is determined that the read address is an address assigned to the first device 200, the first R/W 240, in operation S58, reads data corresponding to the read address from the first disk 260 under the control of the first storage controller 250. The first device 200 transmits the read-out data to the host 100 in operation S72. On the other hand, when it is determined that the read address is not an address assigned to the first device 200, the first device 200 transmits the read command to the second device 300 under the control of the first storage controller 250 in operation S56.

In response to the read command, the second device 300 decodes the read address included in the read command received from the first device 200, and, in operation S60, determines according to a result of the decoding whether the read address is an address assigned to the second device 300. When it is determined that the read address is an address assigned to the second device 300, the second device 300 read data corresponding to the read address in operation S64.

The second device 300 transmits the read-out data to the first device 200 in operation S70. The first device 200 transmits the data received from the second device 300 to the host 100 in operation S72. On the other hand, when it is determined that the read address is not an address assigned to the second device 300, the second device 300 transmits the read command to the third device 400 in operation S62.

In response to the read command, the third device 400 in operation S66 reads data from the third disk 460 according to the read address. The third device 400 transmits the read-out data to the second device 300 in operation S68. In operation S70, second device 300 transmits the data received from the third device 400 to the first device 200,. In operation S72, the first device 200 transmits the data received from the second device 300 to the host 100.

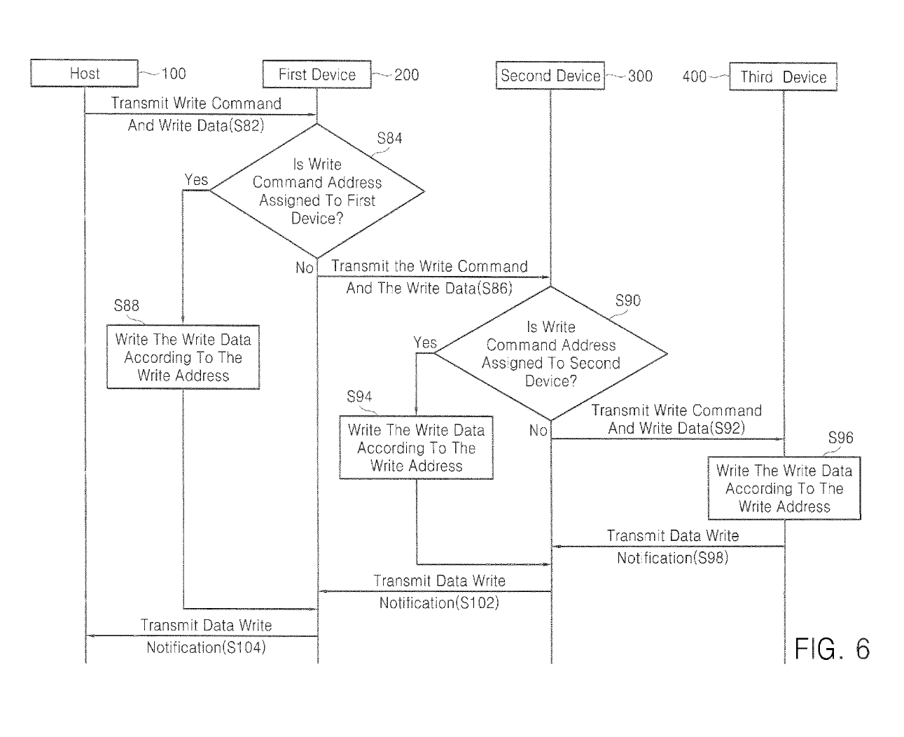

FIG. 6 is a flowchart of a method in which the host 100 writes data to the plurality of devices, namely, the first, second, and third devices 200, 300, and 400, in the storage system 10′ illustrated in FIG. 4. Referring to FIGS. 4 and 6, in operation S82, the host 100 transmits a write command and write data to the first device 200 via the host communication interface 110. In response to the write command, the first device 200 determines in operation S84 whether a write address included in the write command is an address assigned to the first device 200.

When it is determined that the write address is an address assigned to the first device 200, the first device 200, in operation S88, writes the write data to the first disk 260 according to the write address. Then, in operation S104, the first device 200 may transmit a data write notification indicating that the write data has been written, to the host 100. On the other hand, when the write address is not an address assigned to the first device 200, the first device 200 transmits the write command and the write data to the second device 300 in operation S86.

In response to the write command, the second device 300 determines in operation S90 whether the write address included in the write command is an address assigned to the second device 300.

When it is determined that the write address is an address assigned to the second device 300, the second device 300, in operation S94, writes the write data to the second disk 360 according to the write address. Then, in operation S102, the second device 300 transmits a data write notification indicating that the write data has been written, to the first device 200. The first device 200 may transmit the data write notification to the host 100 in operation S104. On the other hand, when it is determined that the write address is not an address assigned to the second device 300, the second device 300 transmits in operation S92 the write command and the write data to the third device 400.

In response to the write command, the third device 400, in operation S96, writes the write data to the third disk 460 according to the write address included in the write command. Then, in operation S98, the third device 400 transmits a data write notification indicating that the write data has been written, to the second device 300. The second device 300 transmits the data write notification to the first device 200 in operation S102. The first device 200 transmits the data write notification to the host 100 in operation S104. In another embodiment of the present general inventive concept, the first, second, and third disks 260, 360, and 460 may be replaced by nonvolatile memories.

A storage system according to an embodiment of the present general inventive concept can connect a host to a device according to an RAID method regardless of whether the host supports an RAID function.

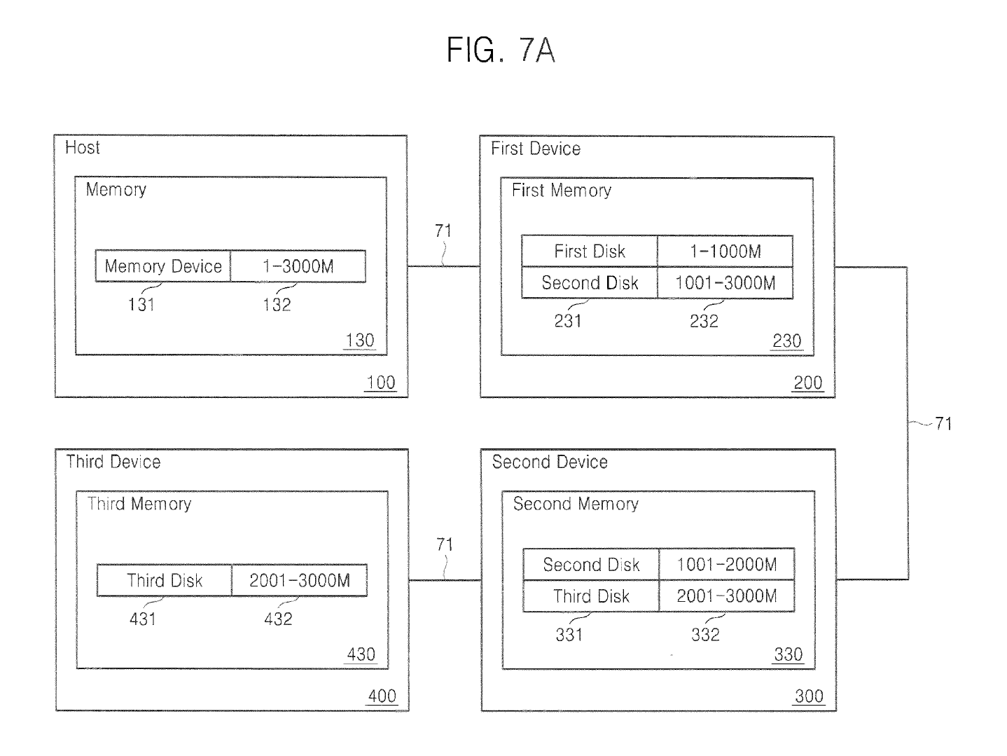

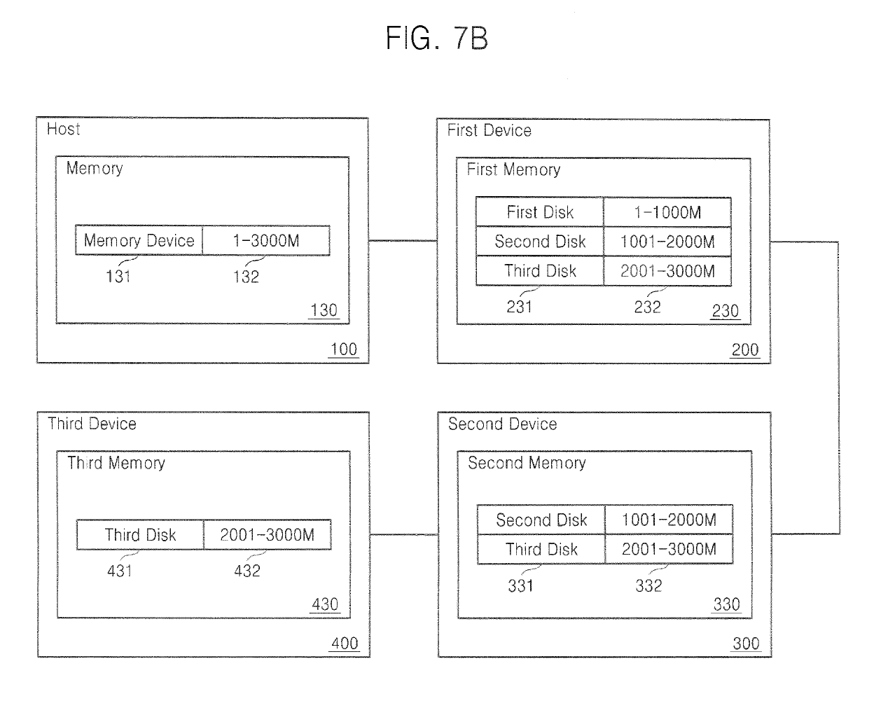

FIGS. 7A and 7B illustrate configurations of memory within each of the host 100 and devices 200, 300, and 400 according to embodiments of the present general inventive concept.

In FIG. 7A, the host 100 stores in memory 130, which may be located in or connected to the controller 120, for example, addresses corresponding to the series of memory devices 200, 300, and 400. However, the devices 200, 300, and 400 are not distinguished in the host memory 130. In other words, the host memory 130 stores the series of devices 200, 300, and 400 as one memory device having a capacity of 3000 Mbytes. The column 131 represents a connected device “Memory Device” as seen by the host 100, and column 132 represents the memory addresses corresponding to the Memory device.

Consequently, the host 100 is configured only to view the memory devices 200, 300, and 400 connected in series as a single memory device, and the host 100 cannot distinguish between the different memory devices 200, 300, and 400 based on the data stored in the host memory 130.

The host 100 and the respective devices 200, 300, and 400, may be connected to each other via a wire 71, such as a serial communication cable.

The first memory 230 of the first device 200 may have stored therein the addresses corresponding to the first disk 260 of the first device 200. However, the first memory 230 may not distinguish between the addresses corresponding to the respective second disk 260 and third disk 360. Instead, the first memory 230 may store all of the addresses corresponding to the second disk 260 and third disk 360 as corresponding to a “Second Disk” in column 231 as a range of addresses in column 232. In other words, from the perspective of the first device 200, which communicates only with the second device 300 in the series of devices 300 and 400, each address that does not correspond to the first disk 260 corresponds to the “Second Disk.”

Accordingly, each device 200, 300, and 400 has stored in a respective memory 230, 330, and 440 addresses corresponding to its own disk (i.e. 260, 360, and 460, respectively) and a range of addresses corresponding to all of the subsequent devices 300 and 400 in the series of devices.

The second memory 330 has stored therein a list of disks 331 including the second disk 360 and a range of all the subsequent disks, which in FIG. 7A is only the third disk 360. The second memory further stores the addresses 332 associated with each of these disks.

The third memory 430 stores a list of disks 431 including the third disk 460 and the addresses 432 associated with the third disk 460. Since no further devices are connected to the third device 400 in FIG. 7A, the third memory 430 does not store addresses corresponding to any additional devices. However, the present general inventive concept is not limited to two or three devices. If an additional device is added to the series by connecting the device to the third device 400, the address information of the additional device would be added to each of the host 100 and devices 200, 300, and 400.

FIG. 7B is similar to FIG. 7A, except the first memory 230 stores addresses 232 corresponding to each of the first disk 260, second disk 360, and third disk 460, and associates each disk in column 231 with its corresponding addresses in column 232. In such a case, if the first device 200 determines that a communication from the host 100 is intended for the third device 400, the first device 200 may add data to the communication from the host 100 to cause the second device 300 to transmit the communication to the third device 400 without analyzing the address information of the communication.

Likewise, the memory 130 of the host 100 may distinguish each range of addresses according to the respective device and may add information to a communication to cause intervening devices to transmit the communication to subsequent or downstream devices without processing address information of the communication.

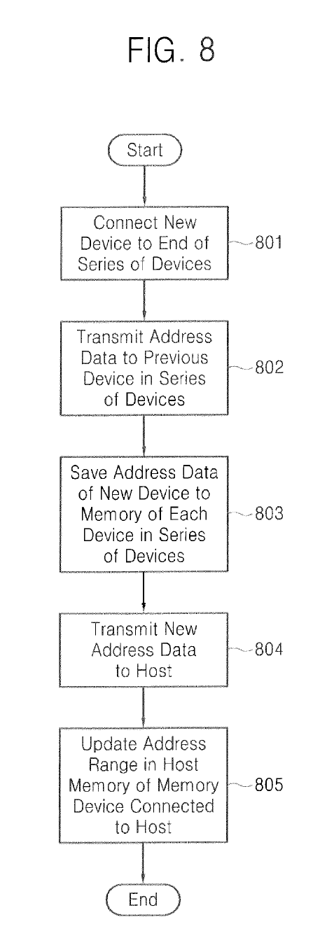

FIG. 8 illustrates an example in which a new device is added to a pre-existing series of devices connected to a host. When a new device is connected to a last memory device in a series of memory devices in operation 801, the new device may transmit information corresponding to the memory addresses on the device to the next device in the series in operation 801. For example, the new device may transmit data that it has a disk capacity of 1000 Mbytes.

In operation 803, each device in the series of devices may save the new address information into the respective memories of the respective devices. For example, referring to FIG. 4, if the third device 400 is the new device, then each of the first device 200 and the second device 300 may add addresses in the first and second memories 230 and 330, respectively, corresponding to the capacity of the new device 400. In addition, the next upstream device (such as the second device 300 in FIG. 4) may transmit to the new device addresses to correspond to its disk capacity. In other words, if the third device 400 is the new device, and the third device has a capacity of 1000 Mbytes, the second device 300 may transmit to the third device 400 information to store in the third memory 430 to assign the addresses 2001-3000 to the disk memory. This communication may be transmitted from the next upstream device 300 immediately upon connecting, or it may be relayed from the first device 200 or the host 100.

The storage capacity of the new device may be transmitted from the first device in the series to the host 100. If one of the devices in the series assigned memory addresses to the new device, the communication from the first device in the series may include the new memory addresses, and the host may update in operation 805 the addresses corresponding to the series of memory devices in the host memory. Alternatively, if the first device transmits the storage capacity of the new device, the host device may determine the addresses to assign to the new device, and may communicate with the first device in the series of devices to update the address range of the series of devices. The first device in the series may transmit the communication from the host to the next device downstream in the series, and each device may update its memory accordingly.

In this manner, any number of memory devices may be added to the series of memory devices to increase the memory capacity connected to the host device 100.

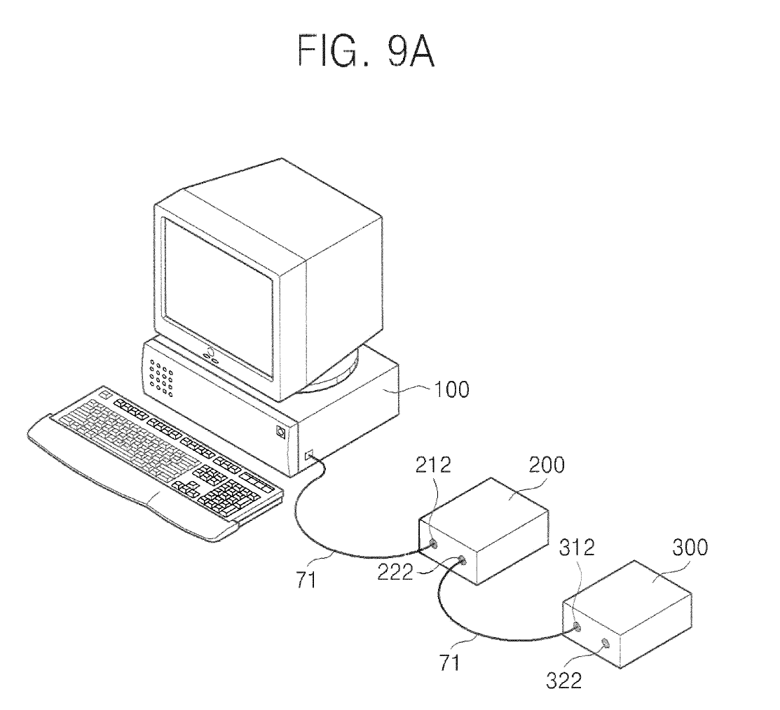

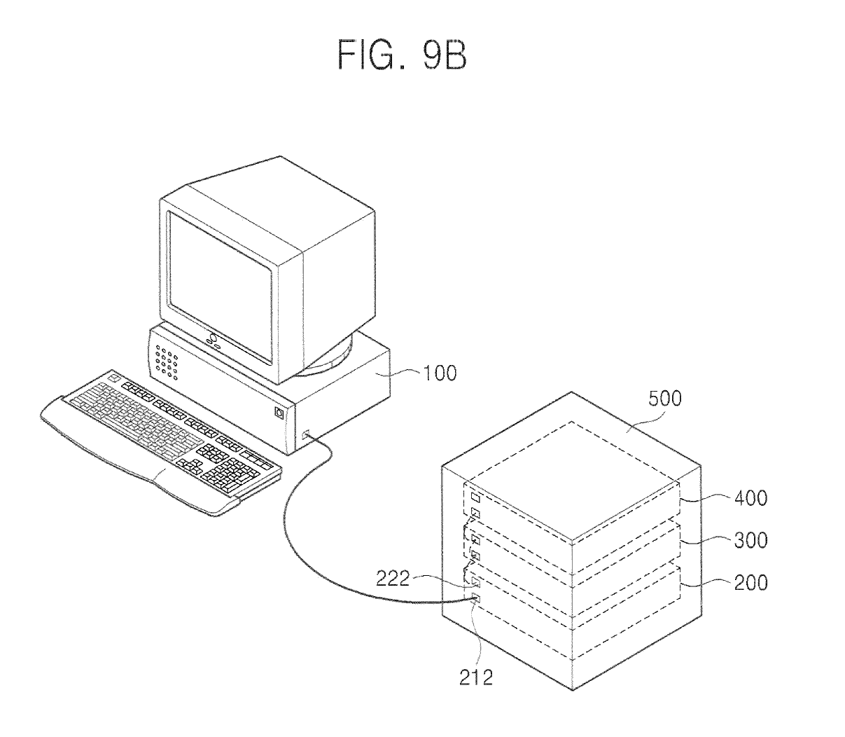

FIGS. 9A and 9B illustrate two examples of configurations of a host device 100 and memory devices 200, 300, and 400. However, it should be noted that the host device 100 and memory devices 200, 300, and 400 connected in series may have any shape, form, or configuration consistent with the above embodiments.

FIG. 9A illustrates a host device 100 as a PC having a serial connection, such as a SATA connection to a first device 200 via a wire or cable 71. The first device 200 has a first port 212 to receive the cable 71 from the host 100 and a second port 222 to connect to the second device 300. Although the second device 300 is the last device in the series of devices, the last device may include each of a first port 312 to receive a cable 71 from the first device 200 and a second port 322 to connect to any subsequent device that may be added to the series of devices.

While FIG. 9A illustrates separate device 200 and 300, the devices 200, 300, and 400 may be included within a single outer cover, shell, or a single memory device 500, as illustrated in FIG. 9B. In such a case, the first device 200 may include a first port 212 to communicate serially with the host 100. However, the second port 222 may be either a serial port or any other communication. For example, the first, second, and third devices 200, 300, and 400 may be connected to each other via one or more printed circuit boards.

While the present general inventive concept has been particularly shown and described with reference to exemplary embodiments thereof, it will be understood that various changes in form and details may be made therein without departing from the spirit and scope of the following claims. For example, while the above embodiments refer in particular to SATA communication, the present general inventive concept may be utilized with any form of serial communication, or with parallel connections between the respective devices.

What is claimed is:

1. A storage system comprising N data processing devices each comprising a data storage device and serially connected to one another, wherein N denotes a natural number,
wherein:
an i-th data processing device from among the N data processing devices accesses a first data storage device of the i-th data processing device or transmits an access command output from a host to an (i+1)th data processing device according to the access command, wherein i denotes a natural number of 1≦i<N; and
the (i+1)th data processing device determines whether to access a second data storage device of the (i+1)th data processing device according to the received access command.

2. The storage system of claim 1, wherein when the i-th data processing device has accessed the first data storage device, the i-th data processing device transmits a result of the accessing to the host.

3. The storage system of claim 1, wherein when the (i+1)th data processing device has accessed the second data storage device, the (i+1)th data processing device transmits a result of the accessing to the host via the i-th data processing device.

4. The storage system of claim 1, wherein when the access command is a read command and the read command includes a read address, the i-th data processing device compares the read address with a first address and reads data corresponding to the read address from the first data storage device and transmits the read-out data to the host, or transmits the read command to the (i+1)th data processing device, according to a result of the comparison, and the (i+1)th data processing device compares the read address included in the read command with a second address and determines according to a result of the comparison whether to access the second data storage device.

5. The storage system of claim 4, wherein when the read address is identical to the second address, the (i+1)th data processing device reads data corresponding to the read address from the second data storage device and transmits the read-out data to the host via the i-th data processing device.

6. The storage system of claim 4, wherein when the read address is not identical to the second address, the (i+1)th data processing device transmits the read command to an (i+2)th data processing device.

7. The storage system of claim 1, wherein when the access command is a write command and the write command includes a write address and write data, the i-th data processing device compares the write address with a first address and writes the write data to the first data storage device or transmits the write command to the (i+1)th data processing device, according to a result of the comparison, and the (i+1)th data processing device compares the write address included in the write command with a second address and determines according to a result of the comparison whether to access the second data storage device.

8. The storage system of claim 7, wherein when the write address is identical to the second address, the (i+1)th data processing device writes the write data to the second data storage device.

9. The storage system of claim 7, wherein when the write address is not identical to the second address, the (i+1)th data processing device transmits the write command to an (i+2)th data storage device.

10. The storage system of claim 1, wherein the i-th data processing device and the (i+1)th data processing device are hard disk drives.

11. The storage system of claim 1, wherein the i-th data storage device and the (i+1)th data storage device are magnetic recording media.

12. The storage system of claim 1, wherein one of the i-th data storage device and the (i+1)th data storage device is one of a magnetic recording medium and a non-volatile memory device.

13. A method of processing data by using a storage system, the storage system comprising N data processing devices each comprising a data storage device and serially connected to one another, wherein N denotes a natural number, the method comprising:
an operation in which an i-th data processing device from among the N data processing devices accesses a first data storage device of the i-th data processing device or transmits an access command output from a host to an (i+1)th data processing device according to the access command, wherein i denotes a natural number of 1≦i<N; and
an operation in which the (i+1)th data processing device determines whether to access a second data storage device of the (i+1)th data processing device according to the received access command.

14. The method of claim 13, wherein when the i-th data processing device has accessed the first data storage device, the i-th data processing device transmits a result of the accessing to the host.

15. The method of claim 13, wherein when the (i+1)th data processing device has accessed the second data storage device, the (i+1)th data processing device transmits a result of the accessing to the host via the i-th data processing device.

16. The method of claim 13, wherein when the access command is a read command and the read command includes a read address, the i-th data processing device compares the read address with a first address and reads data corresponding to the read address from the first data storage device and transmits the read-out data to the host, or transmits the read command to the (i+1)th data processing device, according to a result of the comparison, and the (i+1)th data processing device compares the read address included in the read command with a second address and determines according to a result of the comparison whether to access the second data storage device.

17. The method of claim 16, wherein when the read address is identical to the second address, the (i+1)th data processing device reads data corresponding to the read address from the second data storage device and transmits the read-out data to the host via the i-th data processing device.

18. The method of claim 16, further comprising an operation in which, when the read address is not identical to the second address, the (i+1)th data processing device transmits the read command to an (i+2)th data processing device.

19. The method of claim 13, wherein when the access command is a write command and the write command includes a write address and write data, the i-th data processing device compares the write address with a first address and writes the write data to the first data storage device or transmits the write command to the (i+1)th data processing device, according to a result of the comparison, and the (i+1)th data processing device compares the write address included in the write command with a second address and determines according to a result of the comparison whether to access the second data storage device.

20. The method of claim 19, wherein when the write address is identical to the second address, the (i+1)th data processing device writes the write data to the second data storage device.
